(19) United States
(12) Patent Application Publication
(10) Pub. No.: US 2024/0018913 A1
(43) Pub. Date: Jan. 18, 2024

(54) THROTTLE

(71) Applicant: UT99 AG, 8450 Andeifingen (CH)

(72) Inventor: Othmar RYMANN, Balterswil (CH)

(21) Appl. No.: 17/796,214

(22) PCT Filed: Jan. 28, 2020
(86) PCT No.: PCT/EP2020/052045

§ 371 Date: Jul. 28, 2022

(51) Int. Cl. F02D 9/10; F02M 35/10

(52) U.S. Cl. CPC F02D 9/101; F02M 35/10222

(57) ABSTRACT

A throttle (1) comprising a housing (10, 4) and a throttle body (2), wherein a flow channel (11) is provided in the housing (10, 4), which extends along a longitudinal axis, wherein the throttle body (2) is arranged in the flow channel (11) so as to be rotatable about a transverse axis (A), wherein the transverse axis (A) intersects the longitudinal axis at an angle of 90 degrees, wherein the size of at least one through-opening formed between the housing (10,4) and the throttle body (2) is variable, wherein the throttle body (2) is arranged in a transverse channel (12) which extends along the transverse axis (A), which projects at least partially beyond the circumference of the flow channel (11) and which is closed at its two ends, and wherein the throttle body (2) extends along the transverse axis (A) as far as the two ends of the transverse channel (12) and extends at least partially as far as the circumference of the transverse channel (12).

### FIELD OF THE INVENTION

The present invention relates to a throttle, in particular a throttle for regulating the pressure in a crank chamber of a piston engine.

### DESCRIPTION OF THE PRIOR ART

Prior art throttles are known in the form of fixed orifices, i.e. rigid elements which are arranged in the cross-section of the flow channel and thus reduce the flowable area of the cross-section. Most fixed orifices are designed for normal operation. As a result, when a system with a fixed orifice plate is started up, it creates too much resistance and thus throttles the system too much. Furthermore, engines are sometimes operated at partial load only, or the pressure drop of the turbocharger intake filter changes over time, or the pressure drop of the coalescing filter increases over time, or the engine speed changes. All these circumstances influence the pressure in the crank chamber, making regulation necessary if the most uniform pressure ratios possible are to be realized over time.

Adjustable throttles are therefore used, which can reduce the flow cross-section only slightly in a startup phase and increasingly in normal operation. Circular disc-shaped throttle valves are used in circular flow channels and rectangular ones in rectangular flow channels. To arrange a throttle valve in the flow channel, it is placed in the channel and a shaft is pushed through opposing walls of the channel and through a central recess in the throttle valve. To prevent the throttle from sliding along the longitudinal direction of the shaft, the throttle cap is attached to the shaft. Screws are usually used for fastening. With known throttles, it is therefore necessary to use throttles of different sizes for different sizes of flow cross-sections.

### SUMMARY OF THE INVENTION

One object of the present invention is to provide a throttle which can be used in conjunction with flow channels having different sized cross-sections.

This object is solved by a throttle with the features of claim 1. Further embodiments of the throttle, as well as a system with such throttles, are defined by the features of further claims.

A throttle according to the invention comprises a housing and a throttle body, wherein a flow channel is provided in the housing which extends along a longitudinal axis. The throttle body is arranged in the flow channel so as to be rotatable about a transverse axis, wherein the transverse axis intersects the longitudinal axis at an angle of 90 degrees. By rotating the throttle body, the size of at least one through-opening formed between the housing and the throttle body is variable. The throttle body is arranged in a transverse channel which extends along the transverse axis. The transverse channel projects at least partially beyond the circumference of the flow channel and is closed at its two ends. The throttle body extends along the transverse axis to the two ends of the transverse channel and extends at least partially to the circumference of the transverse channel.

Such a design allows different throttle bodies to be used interchangeably in one housing. The housing is designed for a maximum channel diameter, for which a corresponding throttle body is inserted into the housing of the throttle. If the throttle is to be used together with a conduit system with a smaller conduit diameter, a corresponding throttle body can be inserted into the housing. For example, throttle bodies can be provided for corresponding nominal diameters of 20 mm to 100 mm.

In one embodiment, the diameter of the transverse channel is the same as the diameter of the flow channel. Alternatively, the diameter of the transverse channel can be larger than that of the flow channel. In this case, the angular range over which a rotation of the throttle body leads to a change in the size of the through-opening is reduced. The angular range in which the flow channel is essentially closed by the throttle body increases. In the remaining angular range, a change in angle leads to a greater change in the size of the through-opening.

In one embodiment, the throttle body comprises a centric recess with which it is arranged on a shaft. Thus, the throttle body can be pushed onto the shaft or the shaft can be inserted into the recess of the throttle body, which allows easy replacement of the throttle body.

In one embodiment, the centric recess is a bore. Alternatively, the recess may comprise a projection. In this case, the shaft comprises a cross-section which is complementary thereto and has a recess, for example in the form of a flattening. Thus, the throttle body is arranged on the shaft in a non-rotating manner. Other polygonal cross-sections can also be used. In a further alternative, the throttle body and the shaft comprise a slot and a slot nut is arranged therein as an anti-rotation device.

In one embodiment, the throttle comprises a fixation with which a relative movement between the throttle body and the shaft can be prevented. The relative movement may comprise a rotation about or a displacement along the transverse axis. For example, the fixation comprises a set screw arranged in a threaded hole in the throttle body. Alternatively, a screw may be screwed in. As a further alternative, a threadless pin may be used. The shaft can have a corresponding recess at a suitable location, in which the fixation can engage form-fittingly.

In one embodiment, the throttle comprises two bearings with which the shaft is supported on both sides in the housing. For example, plain bearings or deep groove ball bearings can be used, which are arranged in recesses in the housing.

In one embodiment, the throttle body includes a stop that extends along the transverse axis beyond an end face of the throttle body. For example, the stop can comprise a screw which forms the stop or with which the stop is fastened to the throttle body. Alternatively, the stop can be formed together integrally with the throttle body. A recess is formed in the housing into which the stop projects. For example, the recess comprises a circular segment-shaped groove at the ends of which the stop of the throttle body can abut. The stop can be used to define the two end positions of the throttle body. In other words, the open position and the closed position of the throttle body can be defined.

In one embodiment, the stop extends along the transverse axis into an area located in the projection of the fixture in the mounting direction opposite the shaft. The stop thus forms a securing element that prevents the fixation from falling out of the throttle body. This is important because it can be dangerous if, for example, a grub screw enters the conduit system connected downstream of the throttle.

In one embodiment, the throttle body extends at least to two opposing generatrixes of a cylindrical body whose axis of rotation is congruent with the transverse axis. The throttle body may have recesses which influence the change in size of the through-opening when the angle of the throttle body is changed. In extreme cases, the recesses may extend from the generatrixes to an area adjacent to the centric recess for accommodating the shaft.

In one embodiment, the throttle body comprises a cylindrical body having at least one groove-shaped recess provided in its circumferential surface. The recess extends at least partially along the circumference, from at least one of the generatrixes, with the center plane of the recess being parallel to the end faces of the throttle body. Two, three or more recesses, or grooves, may also be provided, which are arranged parallel to each other with respect to the transverse axis. The distribution of the grooves along the transverse axis can be regular or irregular.

In one embodiment, the at least one recess of the throttle body comprises a substantially triangular cross-section, whereby the at least one recess comprises two adjacent flanks. Alternative groove cross-sections may be circular, elliptical, quadrilateral, or polygonal. In the case of cross-sections with multiple sections, i.e. recesses with multiple flanks, these can be formed straight or curved. The curvatures can be of convex or concave design.

In one embodiment, a transition region between two adjacent flanks of the at least one recess of the throttle body is rounded and forms a groove base. Alternatively, the transition can be angular.

In one embodiment, the at least one recess comprises two sections, wherein a first section adjoins one of the generatrixes and in which the radial distance from the transverse axis to the recess decreases continuously from the generatrix. A second section adjoins the first section, wherein the recess in the second section extends in a direction which is parallel to a straight line which intersects the transverse axis and the generatrixes perpendicularly.

In one embodiment, the throttle comprises a drive which is operatively connected to the throttle body and can rotate it about the transverse axis. The operative connection can be form-fit or force-fit.

In one embodiment, the throttle comprises a return element which counteracts a rotation of the throttle body at least in one direction. The return element can cause a force or a torque in the direction of the open position or the closed position of the throttle body.

In one embodiment, the throttle comprises at least one adapter with a channel which extends along the longitudinal axis, which has the same dimensions at its one end as the flow channel formed in the housing and is connected to the housing with this end at least at one inlet-side end of the flow channel, and which has smaller dimensions on its opposite side. Different adapters with different channel diameters can be provided for different conduits. Adapters may be connected to the housing on both sides of the throttle. The two adapters can be identical or have different channel diameters.

The mentioned embodiments of the throttle can be used in any combination, provided they do not contradict each other.

A system according to the invention comprises an engine with a crankcase, an oil separator, a throttle according to one of the preceding claims and a turbocharger, wherein the crankcase, the oil separator, the throttle and the turbocharger are connected to each other by conduits in a closed circuit. In a closed crankcase, the blow-by gas would increase the pressure in the crank chamber. Without a reduction in pressure, the stress on the seals would be too great and it would not be possible to prevent oil from being expelled from the crank chamber, for example through the crankshaft bearings. It is important to prevent the pressure from rising above a specified value, for example above +20 mbar. To reduce the pressure, gas is discharged from the crank chamber. The gas absorbs oil, or oil mist, in the crank chamber. Since an accumulation of oil in the conduit system must be prevented, it is separated by an oil separator and returned to the crank chamber. A turbocharger draws gas from the crank chamber through the oil separator. The throttle regulates the pressure in the crank chamber. For example, to a negative pressure of −3 mbar. If the pressure is as constant as possible, i.e. if pressure fluctuations are low, the oil separator, for example a coalescence filter, has a higher separation efficiency. The interaction or design of the piston engine together with the turbocharger necessitates a certain design of the throttle. For example, the turbocharger intake negative pressures range from −10 mbar to −100 mbar. The flow rates of the blow-by gas range, for example, from 150 L/min to 5000 L/min. With the throttle according to the invention, these ranges can be covered by using different throttle bodies in different subranges. For example, a first size can be used for a first subrange from 150 L/min to 2500 L/min and a second size for a second subrange from 2500 L/min to 5000 L/min. The subranges of the two sizes can overlap. For example, throttle bodies for nominal diameters of 20 mm to 50 mm can be used in the first subrange and throttle bodies for nominal diameters of 50 mm to 100 mm can be used in a second subrange.

### BRIEF DESCRIPTION OF THE DRAWINGS

Exemplary embodiments of the present invention are explained in further detail below with reference to figures. These are for explanatory purposes only and are not to be construed restrictively. The figures show as follows:

FIG. 1 shows a perspective view of a throttle according to the invention;

FIG. 2 shows a sectional view through the longitudinal and transverse axes of FIG. 1;

FIG. 3 shows a section of a cross-sectional view through the transverse axis of FIG. 1 perpendicular to the sectional view of FIG. 2;

FIG. 4 shows a perspective view of a first embodiment of a throttle body according to the invention;

FIG. 5 shows a perspective view of a second embodiment of a throttle body according to the invention;

FIG. 6 shows a sectional view of FIG. 5 in a center plane perpendicular to the transverse axis; and

FIG. 7 shows a system having a throttle according to the invention.

### DETAILED DESCRIPTION OF THE INVENTION

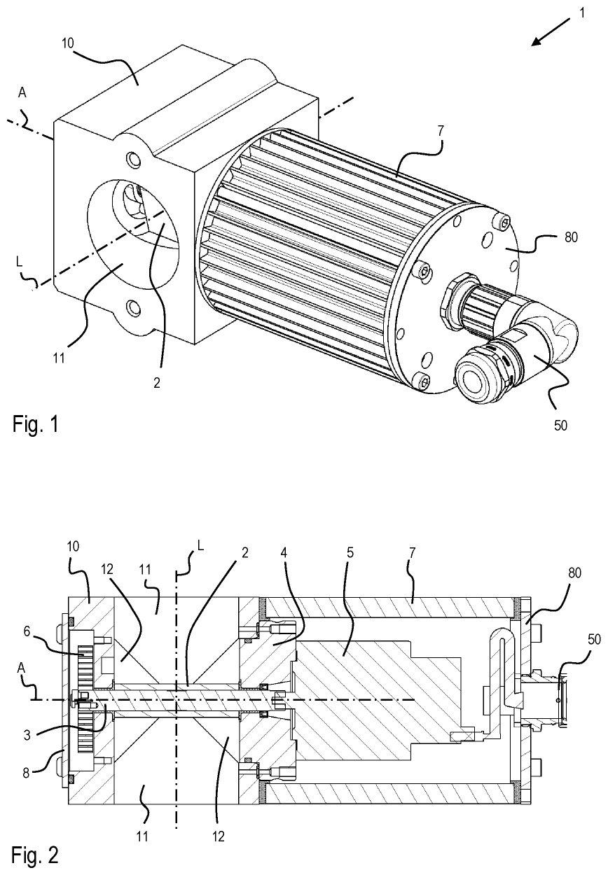

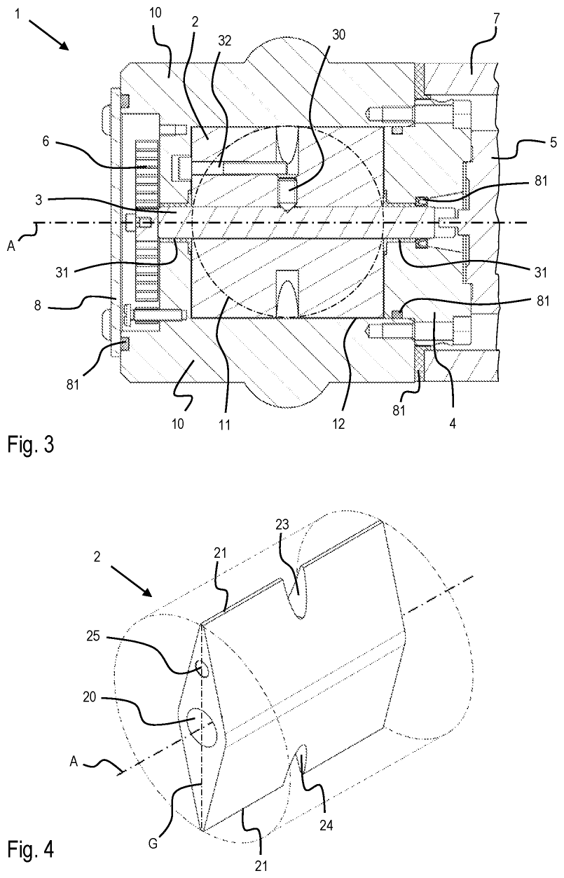

FIG. 1 shows a perspective view of a throttle 1 according to the invention, FIG. 2 shows a sectional view through the longitudinal and transverse axes of FIG. 1 and FIG. 3 shows a section of a sectional view through the transverse axis of FIG. 1 perpendicular to the sectional view of FIG. 2. The throttle 1 comprises a housing 10 with a cover 4 and a throttle body 2, wherein a flow channel 11 is provided in the housing 10 and extends along a longitudinal axis L. The throttle body 2 is arranged rotatably about a transverse axis A in the flow channel 11. The transverse axis A intersects the longitudinal axis L at an angle of 90 degrees. The throttle body 2 is arranged in a transverse channel 12 which extends along the transverse axis A, which projects at least partially beyond the circumference of the flow channel 13 and which is closed at its two ends. The throttle body 2 extends along the transverse axis A to the two ends of the transverse channel 12 and extends at least partially to the circumference of the transverse channel 12. On the engine side, the transverse channel 12 is closed by the cover 4. The cover 4 is screwed to the housing 10. The diameter of the transverse channel 12 is the same as that of the flow channel 11. The throttle body 2 is arranged on a shaft 3, which is rotatably mounted on both sides in the housing 10 or in the cover 4 by means of plain bearings 31. A screw 32 is screwed into the throttle body from one end face of the throttle body 2 along the transverse axis A. The screw head projects along the transverse axis A beyond the end face and serves as a stop. The screwed-in end of the screw 32 projects behind the screwed-in set screw 30 into the threaded hole into which the set screw 30 was screwed, thus preventing it from falling out of the throttle body if it should have come loose. The shaft 3 is operatively connected to a drive 5. The drive 5 is screwed to the cover 4.

The drive 5 is surrounded by a closed, cylindrical cooling jacket 7 with cooling fins, which is screwed to the housing 10 by a cooling jacket cover 80. An electrical connection 50 for the drive 5 is provided on the cooling jacket cover 80. The drive 5 is designed as an electric motor. For example, as a stepper motor with an electronics unit, wherein the electronics unit can comprise a control system, a closed-loop control system and a bus communication system. A return element 6 is arranged on the side of the shaft 3 opposite the motor 5 in a recess in the housing 10 and is operatively connected to the shaft. The return element 6 shown is a spiral spring which is connected in its inner region to the shaft 3 and in its outer region to the housing 10. The recess in which the spiral spring 6 is located is accessible from the outside, closed by a cover 8 and sealed by a closed circumferential seal 81. Further seals 81, between the shaft 3 and the cover 4, between the cover 4 and the housing 10 and between the housing 10 and the cooling jacket 7, prevent gas from being drawn in from the surroundings in the event of a negative pressure in the throttle 1, or prevent gas from being discharged into the surroundings in the event of an excess pressure in the throttle 1.

FIG. 4 shows a perspective view of a first embodiment of a throttle body 2 according to the invention. The throttle body comprises a centric recess 20, with which it can be arranged on a shaft 3, with a cross-section complementary thereto. The recess 20 shown is a through-hole which extends from one end face to an opposite end face thereto. The throttle body 2 extends to two mutually opposite generatrixes 21 of a cylindrical body, the axis of rotation of which is congruent with the transverse axis A. The thickness of the throttle body increases from the generatrixes 21 to the central recess 20. The threaded hole 23 for screwing in the threaded pin 30 extends from the center of one of the two generatrixes 21 in a direction perpendicular to the transverse axis A to the centric recess 20. On the opposite side of the threaded hole 23, another hole 24 is provided for symmetry reasons, which is identical to the threadless part of the threaded hole 23. A further threaded hole 25 is arranged in one of the end faces and extends into the threadless part of the threaded hole 23. The further threaded hole 25 is arranged on a straight line G which intersects the transverse axis A and the generatrix 21 perpendicularly.

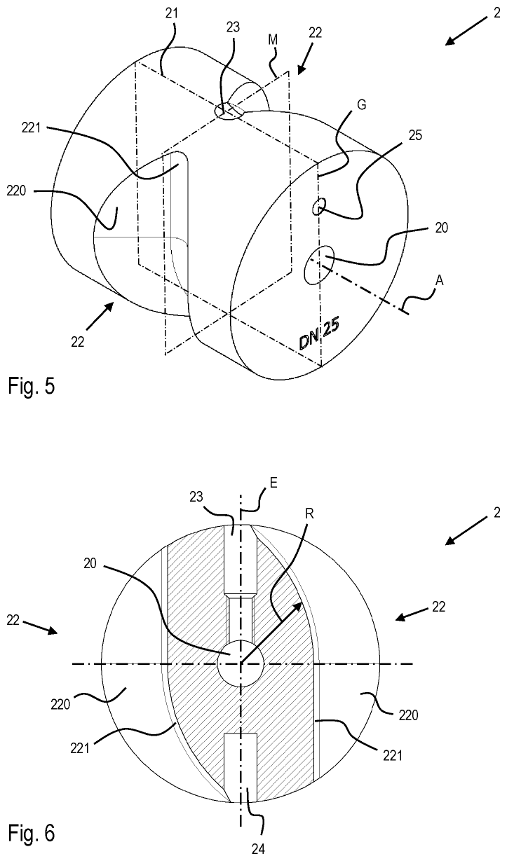

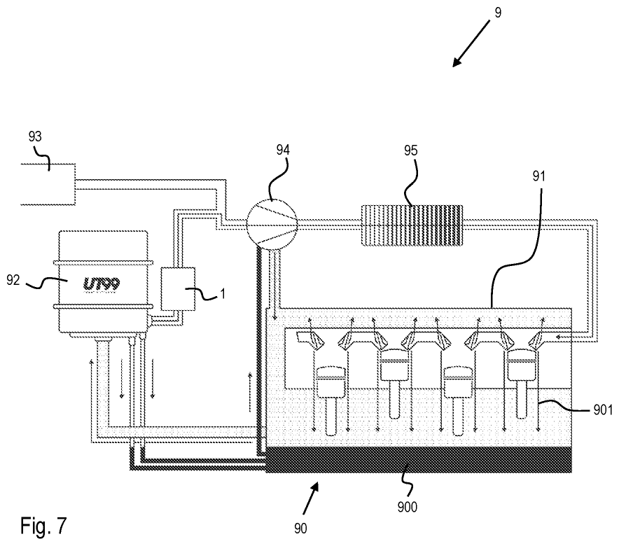

FIG. 5 shows a perspective view of a second embodiment of a throttle body 2 according to the invention, and FIG. 6 shows a sectional view of FIG. 5 in a center plane M perpendicular to the transverse axis A. As in the preceding embodiment, the throttle body 2 shown here comprises a central recess 20, a threaded bore 23 for screwing in the threaded pin, a corresponding symmetry bore 24 and a threaded bore 25 for screwing in the stop screw. In addition, the throttle body 2 shown comprises a cylindrical body, in the circumferential surface of which two groove-shaped recesses rotated by 180 degrees with respect to the transverse axis A are provided, each extending from a generatrix 21, along part of the circumference of the circumferential surface. The center plane M of the recesses is congruent with the center plane M of the two end faces of the throttle body 2. Each of the two recesses has a substantially triangular cross-section with two flanks 220 adjacent to each other. The transition region 221 between the two mutually adjacent flanks 220 is provided with a radius and forms a rounded groove base. Each of the two recesses 22 comprises two sections, wherein a first section adjoins the respective generatrix 21. In this first section, the radial distance R from the transverse axis A to the groove base of the recess 22 decreases continuously from the generatrix 21. This causes the width and depth of the groove to increase. A second section continuously adjoins the first section on the side opposite the generatrix 21. In the second section, the recess 22 extends in a direction which is parallel to a straight line G which intersects the transverse axis A and the generatrixes 21 perpendicularly. Thus, in the fully open state of the throttle body 2, the second section of the recess 22 is parallel to the longitudinal axis L of the flow channel 11.

FIG. 7 shows a system with a throttle 1 according to the invention. The system comprises an internal combustion engine 90 having a crankcase 91, an oil separator 92, a throttle 1 according to the invention and a turbocharger 94, which are connected to each other by conduits in a closed circuit. During operation of the internal combustion engine 90, blow-by gas 901 flows from the interior of the piston into the crank chamber located in the crankcase 91. An oil sump 900 is located in a lower portion of the crankcase 91 for lubricating the moving parts. During operation, oil vapor is generated. To prevent overpressure in the crankcase 91, air is exhausted from the crank chamber with the turbocharger 94 via the oil separator 92 and the throttle 1, creating a negative pressure in the crankcase 91. The blow-by gas 901 is forced into the crank chamber intermittently, creating pressure surges in the closed circuit, resulting in varying flow rates in the circuit. Since the oil separator 92 functions most effectively when the flow rate is as constant as possible, it is regulated by the throttle 1. The system further includes an air filter 93 through which fresh air is drawn in and a cooler 95 with which the fresh air compressed in the turbocharger 94 is cooled. The supercharged and cooled air is then fed to the combustion chambers of the internal combustion engine 90.

LIST OF REFERENCE SIGNS

| | |
|---|---|
| 1 | Throttle |
| 10 | Housing |
| 11 | Flow channel |
| 12 | Transverse channel |
| 2 | Throttle body |
| 20 | Through-hole |
| 21 | Generatrix |
| 22 | Recess |
| 220 | Flank |
| 221 | Base |
| 23 | Fixing hole |
| 24 | Bore |
| 25 | Stop bore |
| 3 | Shaft |
| 30 | Fixation |
| 31 | Bearing |
| 32 | Stop |
| 4 | Flange |
| 5 | Drive |
| 50 | Connection |
| 6 | Return element |
| 7 | Cooling jacket |
| 8 | Cover |
| 80 | Cover |
| 81 | Seal |
| 9 | System |
| 90 | Motor |
| 91 | Housing |
| 92 | Oil separator |
| 93 | Air filter |
| 94 | Turbocharger |
| 95 | Cooler |
| 900 | Oil sump |
| 901 | Blow-by gas |
| A | Transverse axis |
| G | Straight line |
| L | Longitudinal axis |
| M | Center plane |
| R | Radius |

1. A throttle (1) comprising a housing (10, 4) and a throttle body (2), wherein a flow channel (11) is provided in the housing (10, 4) extending along a longitudinal axis (L), wherein the throttle body (2) is arranged in the flow channel (11) so as to be rotatable about a transverse axis (A), wherein the transverse axis (A) intersects the longitudinal axis (L) at an angle of 90 degrees, wherein the size of at least one through-opening formed between the housing (10, 4) and the throttle body (2) can be varied by rotation of the throttle body (2), characterized in that the throttle body (2) is arranged in a transverse channel (12) which extends along the transverse axis (A), which projects at least partially beyond the circumference of the flow channel (11) and which is closed at its two ends, and in that the throttle body (2) extends along the transverse axis (A) as far as the two ends of the transverse channel (12) and extends at least partially as far as the circumference of the transverse channel (12).

2. The throttle (1) according to claim 1, wherein the diameter of the transverse channel (12) is equal to the diameter of the flow channel (11).

3. The throttle (1) according to claim 1, wherein the throttle body (2) comprises a centric recess (20) with which it is arranged on a shaft (3).

4. The throttle (1) according to claim 3, wherein the centric recess (20) is a bore.

5. The throttle (1) according to claim 3, comprising a fixation (30) with which a relative movement between the throttle body (2) and the shaft (3) can be prevented.

6. The throttle (1) according to claim 3, comprising two bearings (31) with which the shaft (3) is mounted on both sides in the housing (10, 4).

7. The throttle (1) according to claim 3, wherein the throttle body (2) comprises a stop (32) which projects along the transverse axis (A) beyond an end face of the throttle body (2).

8. The throttle (1) according to claim 7, wherein the stop (32) extends along the transverse axis in a region located in the projection of the fixation (30) in the mounting direction which is opposite the shaft (3).

9. The throttle (1) according to claim 3, wherein the throttle body (2) extends at least to two mutually opposite generatrixes (21) of a cylindrical body whose axis of rotation is congruent with the transverse axis (A).

10. The throttle (1) according to claim 3, wherein the throttle body (2) comprises a cylindrical body, in the circumferential surface of which at least one groove-shaped recess (22) is provided, which extends at least partially along the circumference, from at least one of the generatrixes (21), wherein the center plane of the recess (22) is parallel to the end faces of the throttle body (2).

11. The throttle (1) according to claim 10, wherein the at least one recess (22) of the throttle body (2) comprises a substantially triangular cross-section, whereby the at least one recess (22) comprises two adjacent flanks (220).

12. The throttle (1) according to claim 11, wherein a transition region (221) between two adjacent flanks (220) of the at least one recess (22) of the throttle body (2) is of rounded design and forms a groove base.

13. The throttle (1) according to claim 10, wherein the at least one recess (22) comprises two sections, wherein a first section adjoins one of the generatrixes (21) and therein the radial distance (R) from the transverse axis (A) to the recess continuously decreases from the generatrix (21), and wherein a second section adjoins the first section, wherein the recess (22) in the second section extends in a direction which is parallel to a straight line (G) which intersects the transverse axis (A) and the generatrixes (21) perpendicularly.

14. The throttle (1) according to claim 1, comprising a drive (5) which is operatively connected to the throttle body (2) and can rotate it about the transverse axis (A).

15. The throttle (1) according to claim 1, comprising a return element (6) which counteracts a rotation of the throttle body (2) at least in one direction.

16. The throttle (1) according to claim 1, comprising at least one adapter with a channel extending along the longitudinal axis (L), which at its one end has the same dimensions as the flow channel (11) formed in the housing (10, 4) and is connected with this end to the housing (10, 4) at least at one inlet-side end of the flow channel (11), and which on its opposite side has smaller dimensions.

17. A system comprising an engine (90) having a crankcase (91), an oil separator (92), a throttle (1) according to one of the preceding claims, and a turbocharger (94), wherein the crankcase (91), the oil separator (92), the throttle (1), and the turbocharger (94) are interconnected by conduits in a closed circuit.
